(19) United States
(12) Patent Application Publication
(10) Pub. No.: US 2026/0356584 A1
(43) Pub. Date: Nov. 12, 2026

(54) AUTOMATED STORAGE AND RETRIEVAL SYSTEM WITH LARGE-SIZED STORAGE CONTAINERS

(71) Applicant: AutoStore Technology AS, Nedre Vats (NO)

(72) Inventors: Asheesh Saraswat, Heggedal (NO); Jørgen Djuve Heggebø, Langhus (NO)

(21) Appl. No.: 19/133,308

(22) PCT Filed: Nov. 23, 2023
(86) PCT No.: PCT/EP2023/082839

§ 371 Date: May 28, 2025

(30) Foreign Application Priority Data
Nov. 29, 2022 (NO) 20221281

(51) Int. Cl. B65G 1/04; B65G 1/06

(52) U.S. Cl. CPC B65G 1/0464; B65G 1/065; B65G 2201/0258

(57) ABSTRACT

The present invention relates to an automated storage and retrieval system (1) comprising a framework structure (100), wherein the framework structure (100) comprises upright members (102), a first storage volume comprising first storage columns (105) provided between the upright members (102), wherein first storage containers (106) are stackable in first stacks (107) within the first storage columns (105) and a second storage volume comprising at least one second storage column (105A) provided between the upright members (102), wherein second storage containers (106A) are stackable in a second stack (107A) within the at least one second storage column (105A). A rail system (108) is provided on top of the upright members (102). A container handling vehicle (301) is arranged to operate on the rail system (108). The container handling vehicle (301) is arranged to handle the first storage containers (106) and the second storage containers (106A). A footprint of each second storage container (106A) is larger than a footprint of the container handling vehicle (301).

### FIELD OF THE INVENTION

The present invention relates to an automated storage and retrieval system comprising a framework structure in which storage containers of different sized can be stored. The present invention also relates to a storage container for an automated storage and retrieval system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

WO 2015197709 describes a robotic object handling system and robotic load handling device for operation thereon. The object handling system comprises a number of robotic load handling devices operational on a grid-like structure, the structure comprising sets of parallel tracks, disposed above a hive of stacked bins. The bins contain inventory items to be picked by the system. Load handling devices capable of carrying multiple bins of a single grid-spacing size or single bins of a multiple grid spacings are operational on the grid and retrieve and transport bins under the control of a computerised order picking utility.

One object of the present embodiment is to enable larger items to be stored in an automated storage and retrieval system in an efficient way.

### SUMMARY OF THE INVENTION

The present invention relates to an automated storage and retrieval system comprising a framework structure, wherein the framework structure comprises:
upright members;
a first storage volume comprising first storage columns provided between the upright members, wherein first storage containers are stackable in first stacks within the first storage columns;
a second storage volume comprising at least one second storage column provided between the upright members, wherein second storage containers are stackable in a second stack within the at least one second storage column; and
a rail system provided on top of the upright members,
   wherein the automated storage and retrieval system comprises a container handling vehicle arranged to operate on the rail system,
   characterized in that
the container handling vehicle is arranged to handle the first storage containers and the second storage containers;
a footprint of each second storage container is larger than a footprint of the container handling vehicle.

As used herein, the term “footprint” is referring to either a footprint length, a footprint width, and/or a footprint area of the second storage container and the container handling vehicle.

As used herein, the term “length” is referred to as a distance measured in a first direction or X-direction, while the term “width” is referred to as a distance measured in a second direction or Y-direction, the second direction being perpendicular to the first direction. Hence, a width of an item may be larger than a length of an item and vice versa.

In one aspect, the container handling vehicle is arranged to handle one of the first storage containers by being able to perform the following actions:
lowering one of the first storage containers in one of the first storage columns;
lifting one of the first storage containers in one of the first storage columns; and/or
carrying one of the first storage containers horizontally above the rail system.

In one aspect, the container handling vehicle is arranged to handle one of the second storage containers by performing the following actions:
lowering one of the second storage containers in one of the second storage columns;
lifting one of the second storage containers in one of the second storage columns; and/or
carrying one of the second storage containers horizontally above the rail system.

According to the above, one type of container handling vehicle can handle the first storage container and the second storage container.

In one aspect, the container handling vehicle comprises a cantilever structure.

In one aspect, the cantilever structure is defining a width of the container handling vehicle;
wherein a width of the second storage container is larger than the width of the container handling vehicle.

In one aspect, the width of the container handling vehicle is equal to the width of the cantilever structure.

Hence, the second storage container protrudes out from below the cantilever structure of the container handling vehicle when handled by the container handling vehicle.

In one aspect, a length of the second storage container is smaller than a length of the container handling vehicle.

In one aspect, a footprint area of the second storage container is larger than a footprint area of the container handling vehicle.

In one aspect, a footprint of each first storage container is equal to or smaller than a footprint of the container handling vehicle.

In one aspect, a width of the first storage container is equal to or smaller than the width of the container handling vehicle.

In one aspect, a length of the first storage container is equal to or smaller than the length of the container handling vehicle.

In one aspect, the footprint of the first container and/or the second container is substantially rectangular.

In one aspect, the second storage column is defined by:
four upright members defining corners of the second storage column;
   wherein the framework structure comprises intermediate upright members, each intermediate upright member being provided between two of the upright members defining the corners of the second storage column;
   wherein each intermediate upright member comprises a guiding protrusion protruding into the second storage column.

In one aspect, framework structure comprises two intermediate upright members or four intermediate upright members. In one aspect, pairs of intermediate upright members are located opposite of each other.

In one aspect, each intermediate upright member and its guiding protrusion are made as one single body being different from the upright members. Alternatively, the guiding protrusion is mounted to the intermediate upright member.

In one aspect, the intermediate upright member is defining a corner for a first storage column being adjacent to the second storage column.

In one aspect, two upright members together with two intermediate upright members of the second storage column serves the same purpose as the four upright members defining the first storage column, which is to guide the gripper device of the container handling vehicle when lowered into or elevated from the column.

In one aspect, the second storage container comprises a first connection interface and a second connection interface.

In one aspect, the second storage container comprises a third connection interface. In one aspect, the connection interfaces are provided adjacent to each other. In one aspect, one of the connection interfaces are partially overlapping the other one of the connection interfaces.

In one aspect, one single container handling vehicle is configured to engage either the first connection interface or the second connection interface, and wherein the second storage container is handled by the one single container handling vehicle.

In one aspect, each of the first connection interface and the second connection interface comprises a gripper interface and a guide pin interface. In one aspect, the guide pin interface is provided as four U-shaped or quarter-circle shaped vertical recesses provided in the second storage container.

In one aspect, the container handling vehicle is configured to engage the first connection interface of the second storage container and wherein a further container handling vehicle of the system is configured to engage the second connection interface of the second storage container; wherein the container handling vehicle and the further container handling vehicle are configured to co-operate during handling of the second storage container.

In one aspect, the second storage container comprises an upper stacking interface and a lower stacking interface, allowing one of the second storage containers to be stacked above or below another one of the second storage containers, either within a second storage column or outside of the framework structure.

In one aspect, the container handling vehicle and the further container handling vehicle each comprises:
a gripper device provided below the cantilever structure for engaging one of the first storage containers or one of the second storage containers during handling of the storage containers;
a lifting device for lifting/lowering the gripper device relative to the cantilever structure;
   wherein the container handling vehicle and the further container handling vehicle are configured to co-operate by synchronous operation of their respective gripping devices and/or lifting devices.

In one aspect, the container handling vehicle and the further container handling vehicle are provided in communication with each other.

In one aspect, the container handling vehicle and the further container handling vehicle are provided in direct communication with each other via a wireless communication interface.

In one aspect, the container handling vehicle and the further container handling vehicle are provided in communication with each other via a control system of the automated storage and retrieval system.

In one aspect, the guide pins of the gripper device of the container handling vehicle are configured to be inserted into the guide pin interface.

In one aspect, the gripper of the gripper device of the container handling vehicle are configured to be inserted into the gripper interface.

In one aspect, the second storage container comprises a guiding recess adapted to the guiding protrusion of the intermediate upright members.

In one aspect, the container handling vehicle comprises a gripper device provided below the cantilever structure for engaging one of the second storage containers during handling of the storage containers; wherein the gripper device comprises a guiding recess adapted to the guiding protrusion of the intermediate upright members.

In one aspect, the second storage containers are sized to correspond to multiple first storage containers.

In one aspect, the second storage container has a length equal to a length of the first storage container and wherein the width of the second storage container is 1.5-3 times the width of the first storage container.

In one aspect, the container handling vehicle comprises a tilt sensor, wherein the container handling vehicle is configured to determine whether or not the container handling vehicle is capable of lifting the second storage container alone based on input from the tilt sensor.

Hence, if the container handling vehicle starts to tilt when starting to lift the second storage container, it can stop the lifting operation. If the second storage container has two connection interfaces, the container handling vehicle may then try to lift the second storage container via the other connection interface, to check if is capable of lifting the second storage container alone based on input from the tilt sensor. This may be the case if the weight is distributed unevenly within the second storage container.

In one aspect, the container handling vehicle is configured to send a message to the control system or to other container handling vehicles if it is determined that the container handling vehicle is not capable of lifting the second storage container alone.

In one aspect, the further container handling vehicle are configured to co-operate during handling of the second storage container based on the message sent from the container handling vehicle.

The present invention also relates to a storage container for an automated storage and retrieval system, wherein the storage container comprises:
a base;
four sides;
a first connection interface provided on top of the four sides, wherein the first connection interface is configured to be engaged by a first container handling vehicle;
a second connection interface provided on top of the four sides, wherein the second connection interface is configured to be engaged by a second container handling vehicle.

In one aspect, the storage container comprises a guiding recess provided in two of the four sides.

In one aspect, the guiding recess is adapted to a guiding protrusion of an intermediate upright member of a framework structure of the automated storage and retrieval system.

### BRIEF DESCRIPTION OF THE DRAWINGS

Following drawings are appended to facilitate the understanding of the invention. The drawings show schematical embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3a is a perspective view of a prior art container handling vehicle having a cantilever for carrying storage containers underneath.

FIG. 3b is a perspective view of the prior art container handling vehicle in FIG. 3a, where the top cover has been removed to show the lifting device more easily.

FIG. 3c is a perspective view from below of the prior art container handling vehicle in FIG. 3b, where details of the lifting device and gripper device are shown in detail.

FIG. 4 is a perspective view, seen from below, of a prior art container handling vehicle having an internally arranged cavity for carrying storage containers therein.

FIG. 5 is a perspective view of a first embodiment of the automated storage and retrieval system.

FIG. 6 is a top view of the first embodiment shown in FIG. 5.

FIG. 7 is a perspective view of the first embodiment, with two container handling vehicles lifting one larger-sized storage container, wherein the width of the container is larger than the width of the container handling vehicle.

FIG. 8 is a side view of FIG. 7.

FIG. 9 is a perspective view of the larger-sized storage container in FIGS. 7 and 8.

FIG. 10 is a top view of the larger-sized storage container in FIG. 9.

FIG. 11 is a top view of a second embodiment of the automated storage and retrieval system.

FIG. 12 is an enlarged view of circle A in FIG. 11.

FIG. 13 is a perspective view of the larger-sized storage container being used in the second embodiment.

FIG. 14 is a top view of the larger-sized storage container in FIG. 13.

FIG. 15 is a perspective view of the second embodiment, with container handling vehicle lifting one larger-sized storage container.

FIG. 16 is a top view of FIG. 15.

FIG. 17 is a side view of FIG. 15.

FIG. 18 is a perspective view of a third embodiment of a larger-sized storage container.

FIG. 19 is a top view of the third embodiment of FIG. 18.

FIG. 20 is a perspective view of a fourth embodiment of a larger-sized storage container.

FIG. 21 is a top view of the fourth embodiment.

FIG. 22 is a perspective view of a gripper device of a container handling vehicle being engaged with the larger-sized storage container of FIGS. 20 and 21.

FIG. 23 is a top view of FIG. 22.

FIG. 24 is perspective view of a further embodiment, with the container handling vehicle lifting the larger-sized storage container shown in FIGS. 18 and 19.

FIG. 25 is a side view of a portion of FIG. 24.

FIG. 26 is a side view of an embodiment in which the length of the second storage container is larger than the length of the container handling vehicle.

FIG. 27 is a side view corresponding to FIG. 26, where two container handling vehicles are cooperating when lifting the storage container.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

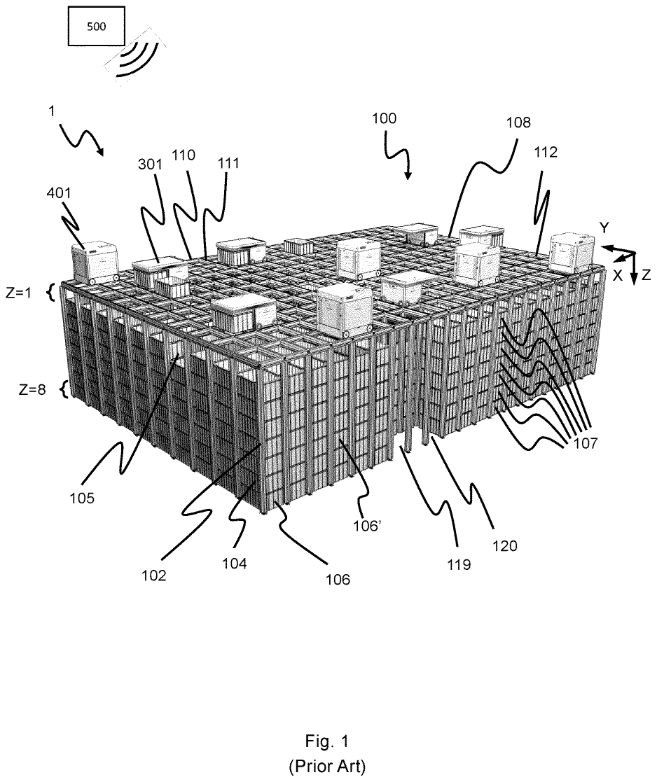

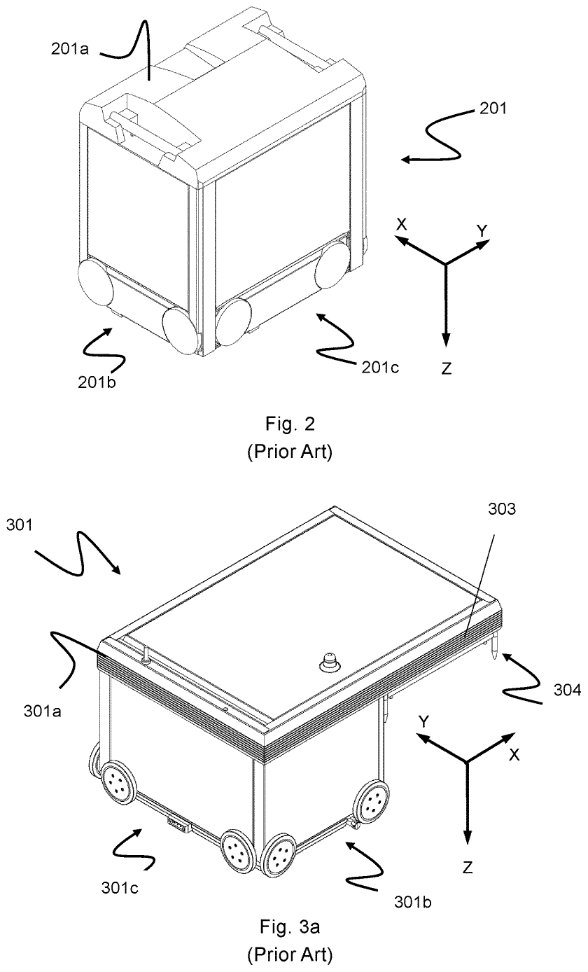

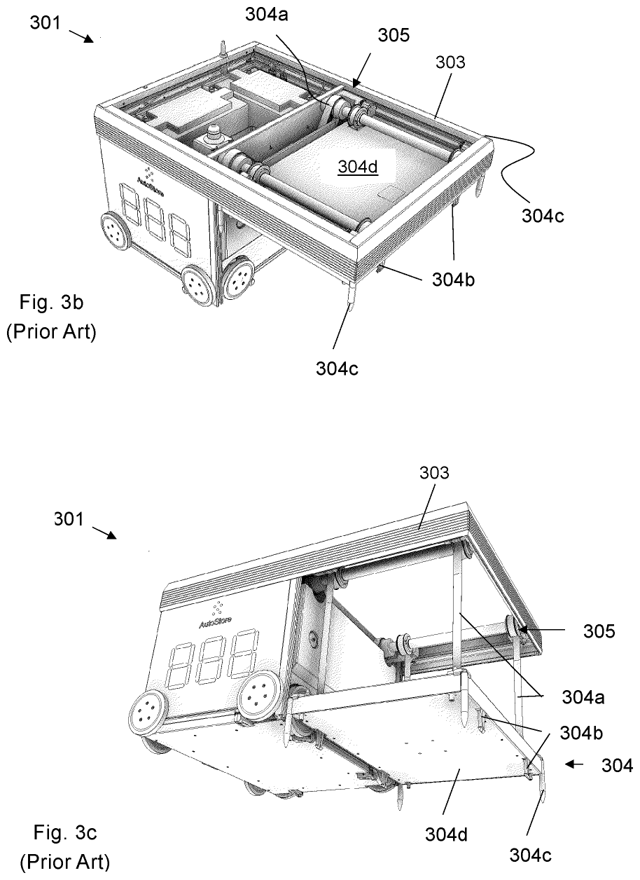

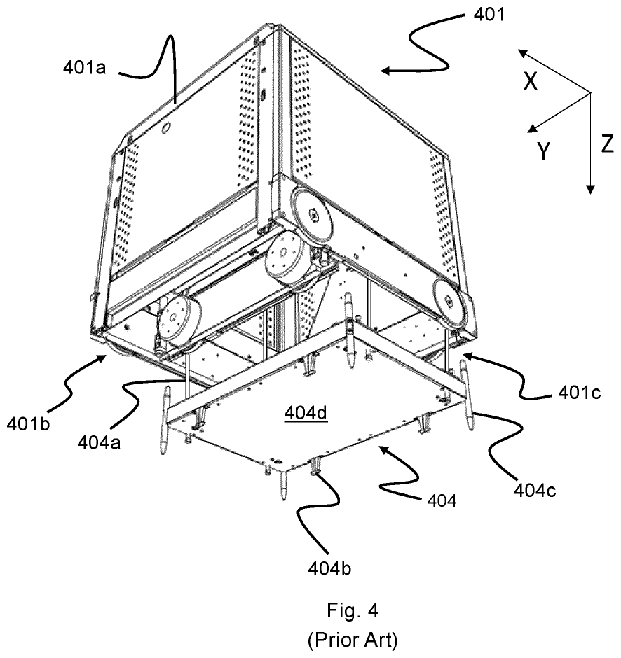

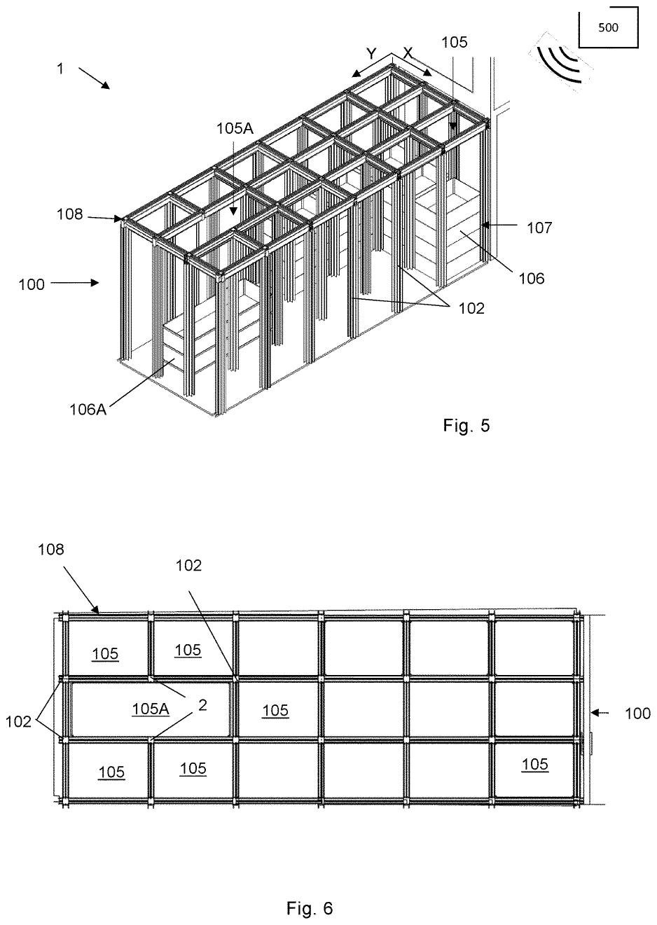

The framework structure 100 of the automated storage and retrieval system 1 shown in FIG. 5 and FIG. 6 is constructed in a similar manner to the prior art framework structure 100 described above in connection with FIGS. 1-3. That is, the framework structure 100 comprises a number of upright members 102, and comprises a rail system 108 extending in the X direction and Y direction.

The framework structure 100 further comprises storage compartments in the form of storage columns 105 provided between the members 102 wherein storage containers 106 are stackable in stacks 107 within the storage columns 105. These storage containers 106, columns 105 and stacks 107 will hereinafter be referred to as first storage containers 106, first columns 105 and first stacks 107.

Even though the framework structure 100 in FIG. 5 and FIG. 6 is relatively small, it can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

In FIG. 5 and FIG. 6 it is further shown that the framework structure 100 comprises a second storage volume comprising at least one second storage column 105A provided between the upright members 102, wherein second storage containers 106A are stackable in a second stack 107A within the at least one second storage column 105A.

As shown in FIG. 5 and FIG. 6, the second storage column 105A is larger than the first storage columns 105 and the second storage containers 106A are larger than the first storage containers 106. It is further shown that the system 1 comprises a control system 500, similar to, but not necessarily identical to, the prior art control system 500.

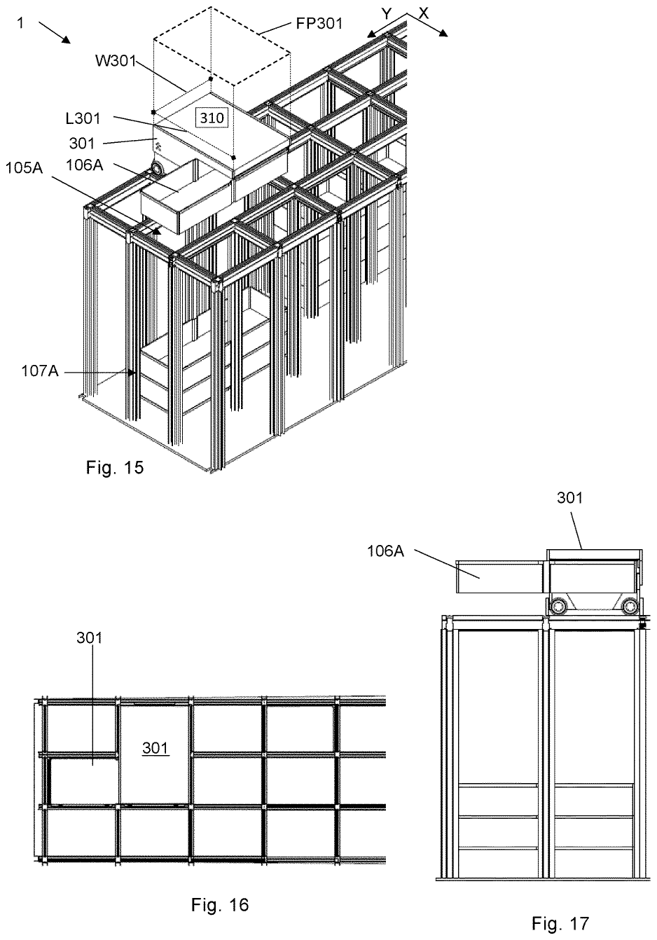

In FIG. 15, it is shown that the system 1 comprises a cantilever type of container handling vehicle 301. The container handling vehicle 301 has a length L301, a width W301 and a footprint area FP301 indicated as a dashed rectangle. As used herein, the term “length” is referred to as a distance measured in the X-direction, while the term “width” is referred to as a distance measured in the Y-direction, the second direction being perpendicular to the first direction.

In FIG. 12, it is shown that the first storage container 106 has a length L106, a width W106 and a footprint area FP106 indicated as a dashed rectangle.

It is further shown that the second storage container 106A comprises a base 106b and four sides 106s protruding up from the base 106b.

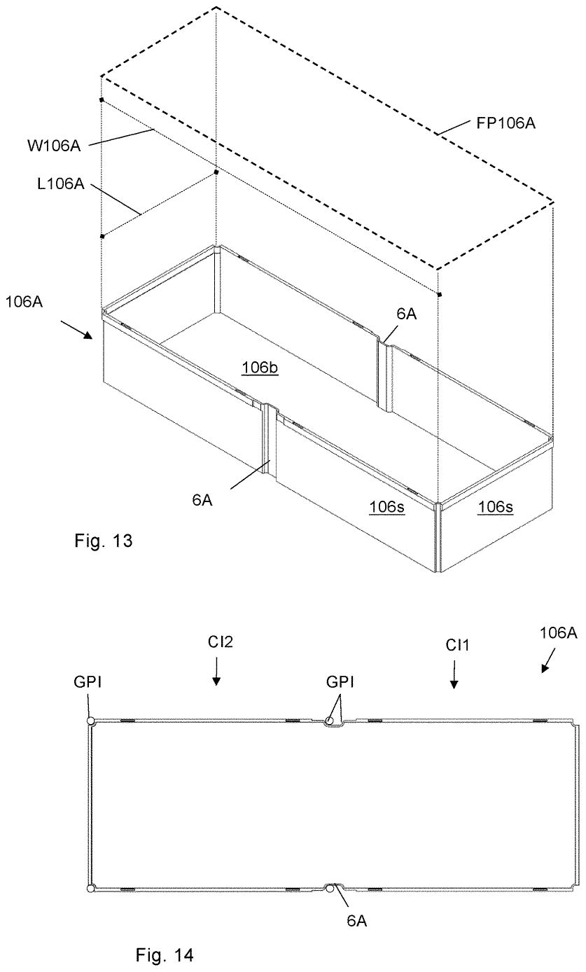

In FIGS. 12 and 13, it is shown that the second storage container 106A has a length L106A being substantially equal to the length L106 of the first storage container, a width W106A being larger than the width W106 of the first storage container and a footprint area FP106A being larger than the footprint area FP106 of the first storage container. The width W106A of the second storage container 106A is here approximately 2× the width W106 of the first storage container 106.

Here it is further shown that the second storage container 106A comprises two connection interfaces CI1, CI2 in the upper part of the sides 106s. Each connection interface CI1, CI2 comprises a gripper interface GI and a guide pin interface GPI.

The gripper interface GI of the second storage container 106A is identical to the gripper interface GI of the first storage container 106A and is hence considered well known for a person skilled in the art. The purpose of the gripper interface GI is to allow a gripper 304d of the gripper device 304 of the container handling vehicle 301 to be inserted into the gripper interface GI and engage the gripper interface, thereby allowing the container handling vehicle 301 to lift the first and second storage containers from above.

The guide pin interface GPI of the second storage container 106A comprises recesses allowing the guide pins 304c of the gripper device 304 of the container handling vehicle 301 to be guided along the guide pin interface GPI. In FIG. 14, the guide pins are indicated as dashed circles for the second connection interface CI2. The purpose of the guide pin interface GPI is to correctly align the gripper device relative to the storage container before the gripper 304d engages the gripper interface GI.

In FIG. 14, the guide pin interface GPI is provided as four quarter-circle shaped vertical recesses provided in the second storage container 106A, two of them being located in the corner of the container, and two of them being located as part of two guiding recesses 6A, which will be described further in detail below. Here, a part of the guiding recess 6A is a part of the first connection interface while another part of the guiding recess 6A is a part of the second connection interface.

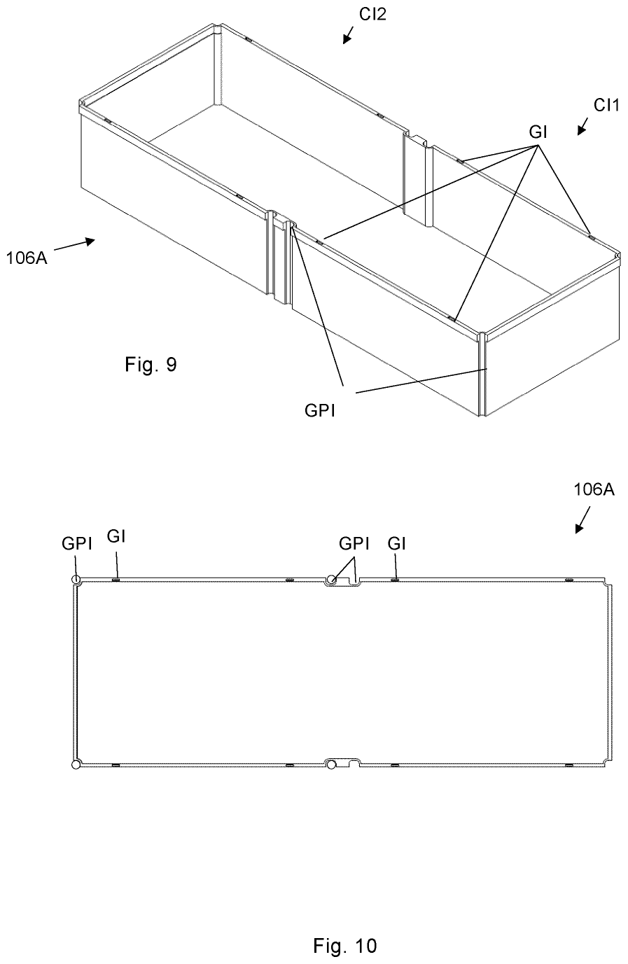

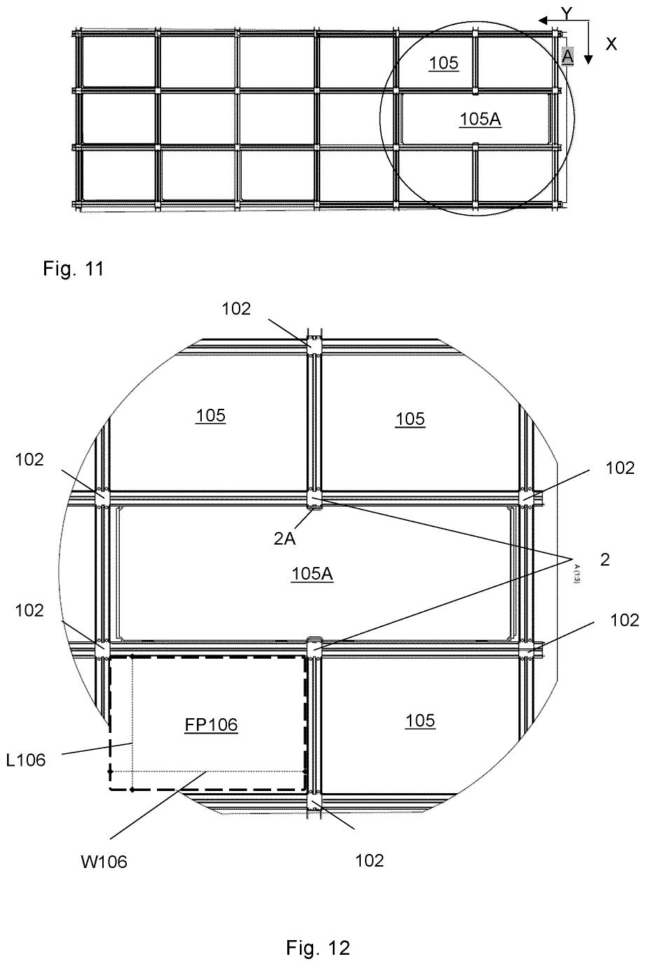

It is now referred to FIG. 9 and FIG. 10, in which another embodiment of the second storage container 106A is shown. Also here, the width W106A of the second storage container 106A is approximately 2× the width W106 of the first storage container 106. Moreover, the second storage container 106A also here comprises two connection interfaces CI1, CI2. Here, the second storage container 106A does not comprise the guiding recess 6A. Hence, two of the recesses are quarter-circle shaped, while two of them are U shaped or half circle shaped.

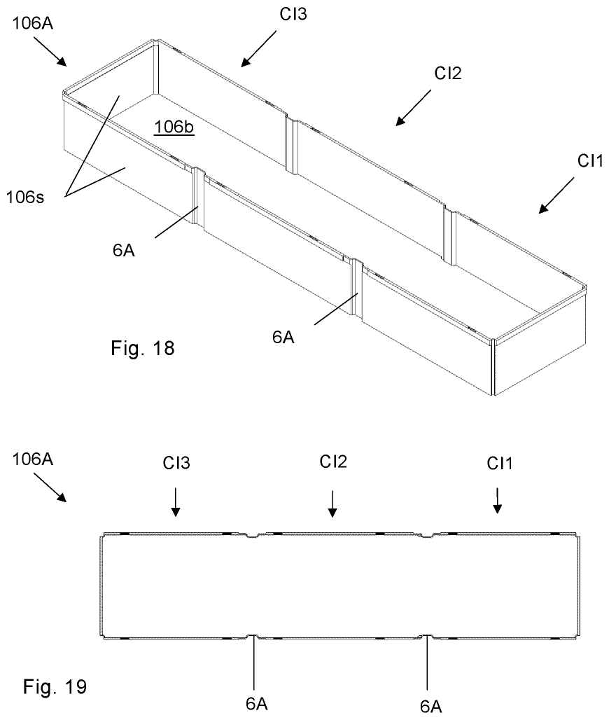

It is now referred to FIG. 18 and FIG. 19 in which another embodiment of the second storage container 106A is shown. Here, the width W106A of the second storage container 106A is here approximately 3× the width W106 of the first storage container 106. Moreover, the second storage container 106A here comprises three connection interfaces CI1, CI2, CI3. The second storage container 106A here has four guiding recesses 6A. The second connection interface CI2 is located in the center of the storage container.

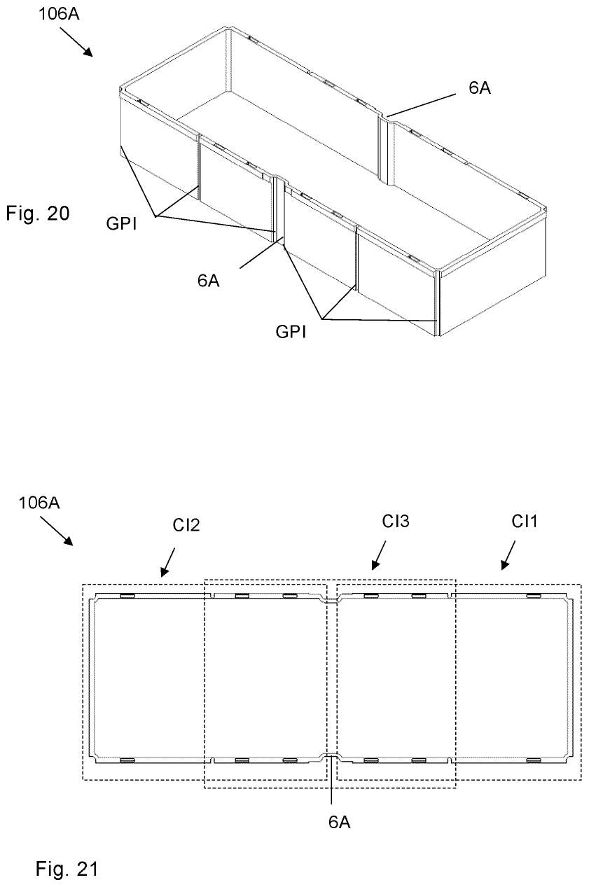

It is now referred to FIGS. 20 and 21 in which another embodiment of the second storage container 106A is shown. Here, the width W106A of the second storage container 106A is here also approximately 2× the width W106 of the first storage container 106. Similar to the embodiment of FIGS. 13 and 14 described above, the second storage container 106A has two guiding recesses 6A and two connection interfaces CI1, CI2 adjacent to each other. In addition, the second storage container 106A comprises a third connection interface CI3 which are partially overlapping the first and second connection interfaces CI1, CI2, as indicated by the dashed rectangles of FIG. 21. The third connection interface CI1 is located in the center of the second storage container.

It is now referred to FIG. 12. As in prior art systems 1, most of the first columns 105 are defined by four upright members 102, one in each corner of the first storage column 105. Each such corner member 102 serves the purpose of guiding the gripper device 304 of the container handling vehicle 301 when lowered into or elevated from one of the first columns 105.

Also the second storage column 105A in FIG. 12 is defined by four upright members 102, one in each corner of the second storage column 105A. In addition, the framework structure 100 comprises intermediate upright members 2, each intermediate upright member 2 being provided between two of the upright members 102 defining the corners of the second storage column 105A. Hence, for the second column 105A, the upright member 2 is not located in the corner. However, the upright members 2 form corners of first storage columns 105 being adjacent to the second column 105A.

In FIG. 12, each intermediate upright member 2 comprises a guiding protrusion 2A protruding into the second storage column 105A.

The purpose of this guiding protrusion 2A is to guide the gripper device 304 of the container handling vehicle 301 when lowered into or elevated from the second column 105A, similar to the corner members 102.

It should be noted that it is the embodiment of the second storage container 106A shown in FIGS. 13 and 14 which is intended for use with the framework structure 100 of FIG. 12. As shown in FIGS. 13 and 14, the shape of the guiding recess 6A is adapted to the shape of the guiding protrusion 2A and the shape of the gripper device 304 of the container handling vehicle 301. As described above, this second storage container 106A has two connection interfaces CI1, CI2. The container handling vehicle 301 will lower its gripper device into the left side of the second storage column 105A in FIG. 12 when engaging one of the connection interfaces, and will lower its gripper device into the right side the second storage column 105A in FIG. 12 when engaging the other one of the connection interfaces. Due to the guiding protrusion 2A, all four corners of the gripper device will be guided when lowered into or elevated from the left side or right side of the second column 105A. This is also illustrated in FIGS. 15, 16 and 17, here the container handling vehicle 301 is located on the right side of the second storage column 105A and is connected to one of the two connection interfaces CI1, CI2 of the second storage container 106A.

It is now referred to FIG. 6. Similar to the embodiment of FIG. 12, the framework structure 100 also here comprises intermediate upright members 2, each intermediate upright member 2 being provided between two of the upright members 102 defining the corners of the second storage column 105A. However, the intermediate upright members 2 do not comprise the guiding protrusion 2A above.

It should be noted that it is the embodiment of the second storage container 106A shown in FIGS. 9 and 10 which is intended for use with the framework structure 100 of FIG. 6, as this second storage container 106A does not comprise a guiding recess 6A. It should be noted that only two of the corners of the gripper device will be guided when lowered into or elevated from the left side or right side of the second column 105A of FIG. 6. However, this is considered acceptable for some applications.

It should further be noted that while the second storage container 106A of FIGS. 9 and 10 cannot be used in the framework structure of FIG. 12, the second storage container 106A of FIGS. 13 and 14 can be used in the framework structure of FIG. 6.

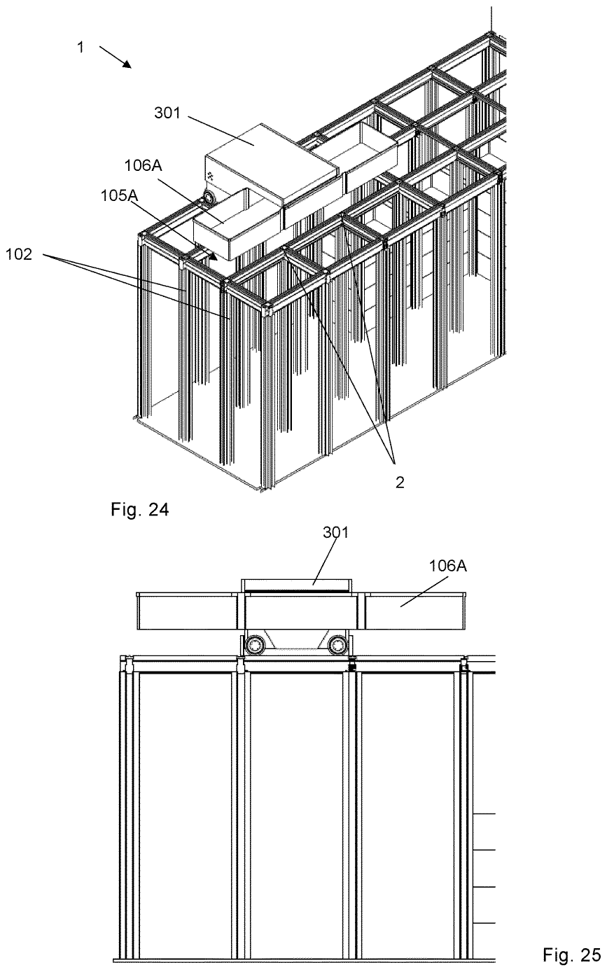

It is now referred to FIGS. 24 and 25. Similar to the embodiment of FIG. 12, the framework structure 100 also here comprises intermediate upright members 2. However, here there are two intermediate upright members 2 being provided between two of the upright members 102 defining the corners of the second storage column 105A. In total, there are four intermediate upright members 2 and four upright members 102 defining the second storage column 105A. Also here, the intermediate upright members 2 comprises a guiding protrusion 2A. As shown in FIGS. 18 and 19, the second storage container 106A intended for use in the framework structure 100 of FIGS. 24 and 25 comprises four guiding recesses 6A.

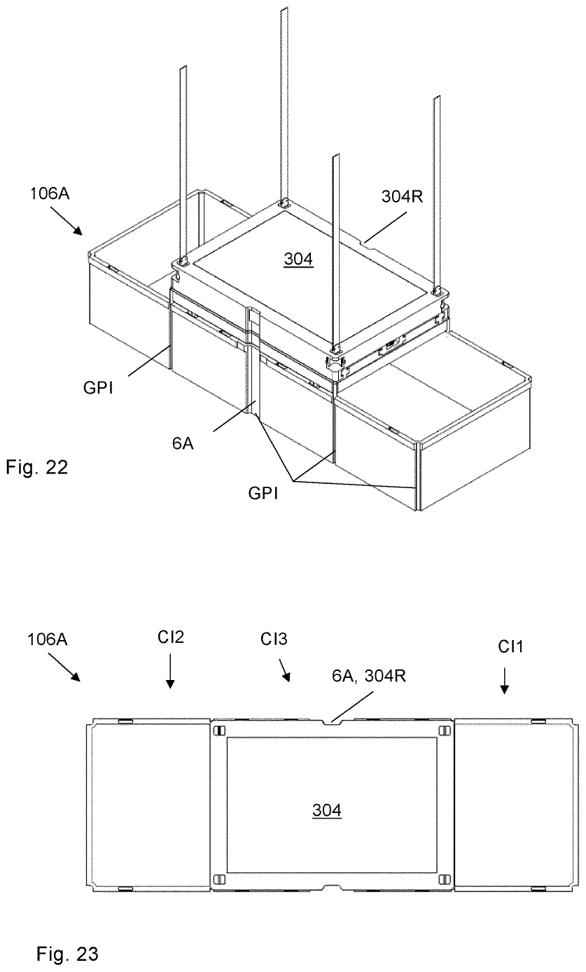

It is now referred to FIGS. 22 and 23. The second storage container shown in FIGS. 20 and 21 may be used in the framework structure 100 shown in FIG. 12 and FIG. 15 17, i.e. the intermediate upright members 2 also here comprise the guiding protrusion 2A above.

The second storage container 106A may be engaged by two container handling vehicles 301, 301a, via its first and second connection interfaces CI1, CI2. However, the storage container 106A may also be engaged by one single container handling vehicle via either the first, the second or the third connection interface. Preferably, when lifted by one single container handling vehicle, the container handling vehicle will engage the central, third connection interface CI3.

The container handling vehicle may have a special gripper device 304 as shown in FIGS. 22 and 23. Here it is shown that the gripper device 304 comprises a guiding recess 304R adapted to the guiding protrusion of the intermediate upright members. Hence, guiding of the gripper device 304 is achieved also when lowering the gripper device towards the third connection interface CI3 and when elevating the gripper device up from the third connection interface CI3.

In all of the above embodiments, the same container handling vehicle 301 is arranged to handle both the first storage containers 106 and the second storage containers 106A. Moreover, the width W106A of the second storage container 106A is larger than the width W301A of the container handling vehicle 301, causing the second storage container 106A to protrude sideways out from below the cantilever structure 303 of the container handling vehicle 301 when handled by the container handling vehicle 301.

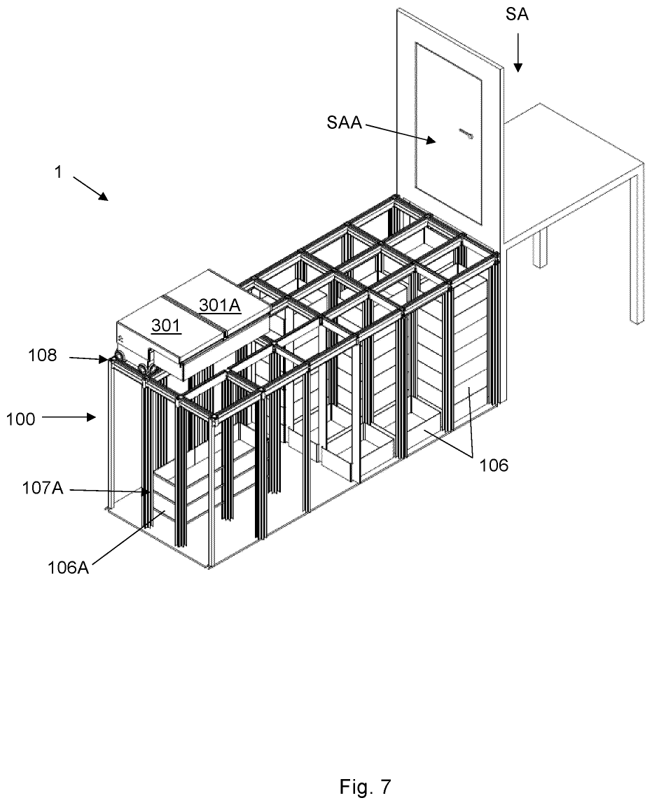

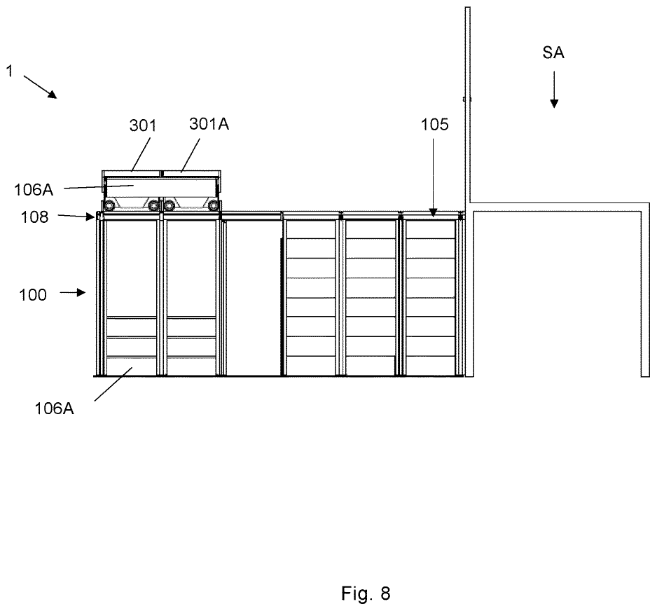

In the second storage container 106A, longer objects may be stored than in the first storage containers 106. Some such longer objects may be relatively light-weight, and hence, one container handling vehicle 301 may be capable of lifting the second storage container 106A with its content alone. However, the sum of the weight of the longer objects and the increased weight of the larger second storage container 106A may be too large for one container handling vehicle. In such a situation, as illustrated in FIG. 7 and FIG. 8, a first container handling vehicle 301 may be used to engage the first connection interface CI1 of the second storage container 106A and a second container handling vehicle 301a may be used to engage the second connection interface CI2 of the second storage container 106A. Here, the container handling vehicle 301 and the further container handling vehicle 301a are configured to co-operate by synchronous operation of their respective gripping devices 304 and/or lifting devices 305. The vehicles 301, 301a may be provided in communication with each other, either directly or via the control system 500.

In FIG. 7, the container handling vehicle 301 and the further container handling vehicle 301 are lifting the second storage container 106A from the same side, i.e. the cantilever structures of the respective vehicles are pointing in the same direction. It should be noted that it is also possible that the container handling vehicle 301 and the further container handling vehicle 301 are lifting the second storage container 106A from the opposite sides.

The container handling vehicle 301 may further comprise a tilt sensor 310, wherein the container handling vehicle 301 is configured to determine whether or not the container handling vehicle is capable of lifting the second storage container 106A alone based on input from the tilt sensor 310. This may be the case for second storage containers 106A with two connection interfaces, wherein the weight of the objects stored in the container is not evenly distributed.

Hence, if the container handling vehicle 301 starts to tilt when starting to lift the second storage container 106A, it can stop the lifting operation. If the second storage container 106A has two connection interfaces, the container handling vehicle may then try to lift the second storage container via the other connection interface, to check if is capable of lifting the second storage container 106A alone based on input from the tilt sensor 310. This may be the case if the weight is distributed unevenly within the second storage container. If this is not possible, then the above further container handling vehicle 301a may be requested for assistance, for example by sending a message to the control system 500 or to other container handling vehicles 301 if it is determined that the container handling vehicle is not capable of lifting the second storage container 106A alone.

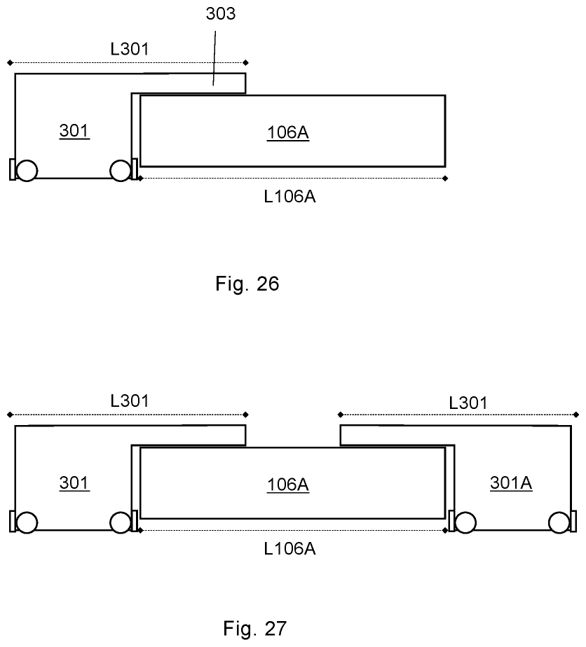

It is now referred to FIG. 26. Here, the second storage container 106A has a length L106A being longer than the length L301 of the container handling vehicle 301. In this embodiment, the width W106A of the second storage container 106A is equal to, or larger than the width W301A of the container handling vehicle 301. Here, the second storage container 106A is protruding from the front out from below the cantilever structure 303 of the container handling vehicle 301 when handled by the container handling vehicle 301.

As shown in FIG. 27, the container handling vehicle 301 and the further container handling vehicle 301A are here lifting the second storage container 106A from opposite sides, i.e. the cantilever structures of the respective container handling vehicles are pointing in opposite directions.

In the preceding description, various aspects of the second storage containers and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 retrieval system
2 intermediate upright members
2A guiding protrusion
6A guiding recess
100 framework structure
102 Upright members of framework structure
104 Storage grid
105 first storage columns
105A second storage column
106 first storage containers
106A second storage containers
106b Base of storage container
106s Side of storage container
106′ Particular position of storage container
107 first stacks
107A second stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 container handling vehicle
301A second container handling vehicle
303 cantilever structure
304 gripper device
304c guide pins
304d gripper
304R guiding recess of gripper device
305 lifting device
310 tilt sensor
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 control system
CI1 first connection interface
CI2 second connection interface
CI3 third connection interface
FP106 footprint area of first storage container
FP106A footprint area of second storage container
FP301 footprint area of container handing vehicle
GI gripper interface
GPI guide pin interface

1.-20. (canceled)

21. An automated storage and retrieval system comprising a framework structure, wherein the framework structure comprises:
upright members;
a first storage volume comprising first storage columns provided between the upright members, wherein first storage containers are stackable in first stacks within the first storage columns;
a second storage volume comprising at least one second storage column provided between the upright members, wherein second storage containers are stackable in a second stack within the at least one second storage column; and
a rail system provided on top of the upright members,
wherein the automated storage and retrieval system comprises a container handling vehicle arranged to operate on the rail system, characterized in that
the container handling vehicle is arranged to handle the first storage containers and the second storage containers;
a footprint of each second storage container is larger than a footprint of the container handling vehicle.

22. The automated storage and retrieval system according to claim 21, wherein the container handling vehicle comprises a cantilever structure.

23. The automated storage and retrieval system according to claim 22, wherein the cantilever structure is defining a width of the container handling vehicle;
wherein a width of the second storage container is larger than the width of the container handling vehicle.

24. The automated storage and retrieval system according to claim 23, wherein a length of the second storage container is smaller than a length of the container handling vehicle.

25. The automated storage and retrieval system according to claim 21, wherein a footprint area of the second storage container is larger than a footprint area of the container handling vehicle.

26. The automated storage and retrieval system according to claim 23, wherein the second storage column is defined by:
four upright members defining corners of the second storage column;
wherein the framework structure comprises intermediate upright members, each intermediate upright member being provided between two of the upright members defining the corners of the second storage column;
wherein each intermediate upright member comprises a guiding protrusion protruding into the second storage column.

27. The automated storage and retrieval system according to claim 23, wherein the second storage container comprises a first connection interface and a second connection interface.

28. The automated storage and retrieval system according to claim 27, wherein one single container handling vehicle is configured to engage either the first connection interface or the second connection interface, and wherein the second storage container is handled by the one single container handling vehicle.

29. The automated storage and retrieval system according to claim 27, wherein the container handling vehicle is configured to engage the first connection interface of the second storage container and wherein a further container handling vehicle of the system is configured to engage the second connection interface of the second storage container; wherein the container handling vehicle and the further container handling vehicle are configured to co-operate during handling of the second storage container.

30. The automated storage and retrieval system according to claim 29, wherein the container handling vehicle and the further container handling vehicle each comprises:
a gripper device provided below the cantilever structure for engaging one of the first storage containers or one of the second storage containers during handling of the storage containers;
a lifting device for lifting/lowering the gripper device relative to the cantilever structure;
wherein the container handling vehicle and the further container handling vehicle are configured to co-operate by synchronous operation of their respective gripping devices and/or lifting devices.

31. The automated storage and retrieval system according to claim 30, wherein the container handling vehicle and the further container handling vehicle are provided in communication with each other.

32. The automated storage and retrieval system according to claim 26, wherein the second storage container comprises a guiding recess adapted to the guiding protrusion of the intermediate upright members.

33. The automated storage and retrieval system according to claim 26, wherein the container handling vehicle comprises a gripper device provided below the cantilever structure for engaging one of the second storage containers during handling of the storage containers;
wherein the gripper device comprises a guiding recess adapted to the guiding protrusion of the intermediate upright members.

34. The automated storage and retrieval system according to claim 21, wherein the second storage containers are sized to correspond to multiple first storage containers.

35. The automated storage and retrieval system according to claim 21, wherein the second storage container has a length equal to a length of the first storage container and wherein the width of the second storage container is 1.5-3 times the width of the first storage container.

36. The automated storage and retrieval system according to claim 21, wherein the container handling vehicle comprises a tilt sensor, wherein the container handling vehicle is configured to determine whether or not the container handling vehicle is capable of lifting the second storage container alone based on input from the tilt sensor.

37. The automated storage and retrieval system according to claim 36, wherein the container handling vehicle is configured to send a message to a control system or to other container handling vehicles if it is determined that the container handling vehicle is not capable of lifting the second storage container alone.

38. The automated storage and retrieval system according to claim 37, wherein the container handling vehicle are further configured to co-operate during handling of the second storage container based on the message sent from the container handling vehicle.

39. A storage container for an automated storage and retrieval system, wherein the storage container comprises:
a base;
four sides;
a first connection interface provided on top of the four sides, wherein the first connection interface is configured to be engaged by a first container handling vehicle;
a second connection interface provided on top of the four sides, wherein the second connection interface is configured to be engaged by a second container handling vehicle.

40. The storage container according to claim 39, wherein the storage container comprises a guiding recess provided in two of the four sides.
